(19) United States
(12) Patent Application Publication
(10) Pub. No.: US 2016/0061436 A1
(43) Pub. Date: Mar. 3, 2016

(54) Socket and Lighting Device

(71) Applicant: Toshiba Lighting & Technology Corporation, Yokosuka-shi (JP)

(72) Inventor: Kiyokazu Hino, Yokosuka-shi (JP)

(73) Assignee: TOSHIBA LIGHTING & TECHNOLOGY CORPORATION, Yokosuka-shi (JP)

(21) Appl. No.: 14/661,759

(22) Filed: Mar. 18, 2015

(30) Foreign Application Priority Data
Aug. 27, 2014 (JP) 2014-172470
Aug. 27, 2014 (JP) 2014-172473

(51) Int. Cl. F21V 29/74; F21K 99/00

(52) U.S. Cl. CPC F21V 29/74; F21K 9/30; F21Y 2101/02

(57) ABSTRACT

According to one embodiment, a socket includes a flange section in which a light emitting module having a light emitting element is provided; a first convex section that protrudes from a surface of the flange section opposite to a side on which the light emitting module is provided and has a plate shape; and a second convex section that protrudes from the surface of the flange section opposite to the side on which the light emitting module is provided and is connected to the first convex section. A top surface of the second convex section is positioned further on the flange section side with respect to a top surface of the first convex section.

### CROSS-REFERENCE TO RELATED APPLICATIONS

This application is based upon and claims the benefit of priority from Japanese Patent Application No. 2014-172470, filed on Aug. 27, 2014, Japanese Patent Application No. 2014-172473, filed on Aug. 27, 2014; the entire contents of which are incorporated herein by reference.

### FIELD

Embodiments described herein relates generally to a socket and a lighting device.

### BACKGROUND

A lighting device includes a light emitting module having a plurality of light emitting diodes (LED), and a socket housing the light emitting module.

Heat generated in the light emitting diode is mainly discharged to the outside through the socket. Thus, the socket is formed of a material having a high thermal conductivity.

Although the material having the high thermal conductivity is a metal such as aluminum, from the point of view of lightweight, a thermally conductive resin including filler made of carbon and the like is used as the material of the socket.

Here, if a content of the filler is increased, it is possible to increase the thermal conductivity. However, if the content of the filler is increased, there is a problem that brittleness is increased and resistance (mechanical strength) to an external force is lowered.

Thus, development of technique is desired which can improve heat dissipation and the resistance with respect to the external force.

### BRIEF DESCRIPTION OF THE DRAWINGS

FIG. 1 is a schematic perspective view illustrating a lighting device according to an exemplary embodiment;

FIG. 2 is a schematic exploded view of the lighting device;

FIG. 3 is a schematic plan view of a light emitting module;

FIG. 4 is a view of the lighting device viewed from a rear surface side;

FIG. 5 is a cross-sectional view that is taken along line A-A in FIG. 4;

FIGS. 6A to 6C are schematic cross-sectional views illustrating a cross-sectional shape of a convex section;

FIG. 7 is a schematic perspective view illustrating a lighting device according to another exemplary embodiment;

FIG. 8 is a schematically exploded perspective view of the lighting device;

FIG. 9 is a view of the lighting device viewed from a rear side; and

FIG. 10 is a cross-sectional view that is taken along line B-B in FIG. 9.

### DETAILED DESCRIPTION

A socket according to an exemplary embodiment includes: a flange section in which a light emitting module having a light emitting element is provided; a first convex section that protrudes from a surface of the flange section opposite to a side on which the light emitting module is provided and has a plate shape; and a second convex section that protrudes from the surface of the flange section opposite to the side on which the light emitting module is provided and is connected to the first convex section.

A top surface of the second convex section is positioned further on the flange section side with respect to a top surface of the first convex section.

In this socket, it is possible to improve heat dissipation and resistance with respect to an external force.

Furthermore, a plurality of first convex sections may be provided and the second convex section may be provided between one first convex section and another first convex section.

The second convex section may be connected to at least one of the one first convex section and the other first convex section.

In this case, it is possible to further improve the resistance with respect to the external force.

Furthermore, the second convex section may have a first surface intersecting the first convex section and a second surface facing the first surface.

At least one of the first surface and the second surface is inclined such that a distance between the first surface and the second surface is gradually shortened toward the top surface of the second convex section.

In this case, since air flow is smooth, it is possible to improve the heat dissipation.

Furthermore, a plurality of second convex sections may be provided, and the first surface of each of the plurality of second convex sections may be inclined in the same direction.

In this case, even if the plurality of second convex sections are provided, the air flow is smooth. Thus, it is possible to improve the heat dissipation.

Furthermore, a plurality of second convex sections may be provided, and the second surface of each of the plurality of second convex sections may be inclined in the same direction.

In this case, even if the plurality of second convex sections are provided, the air flow is smooth. Thus, it is possible to improve the heat dissipation.

A third convex section that is connected to the first convex section may be further provided.

The flange section may have a base section, a convex section which protrudes from one surface of the base section and in which the light emitting module is provided, and a concave section that is provided on a surface of the base section opposite to a side on which the light emitting module is provided.

The first convex section may protrude from the surface of the base section opposite to the side on which the light emitting module is provided.

The third convex section may be provided inside of the concave section and protrude from the surface of the base section opposite to the side on which the light emitting module is provided.

A top surface of the third convex section may be positioned further on the base section side with respect to the top surface of the first convex section.

In this case, it is possible to improve heat dissipation and resistance with respect to an external force.

Furthermore, since a mounting position of the light emitting module can be near a front side of the socket, it is possible to prevent the light emitted from the light emitting diode from being blocked by the socket.

In this case, the third convex section is provided inside of the concave section and protrudes from the surface of the base section opposite to the side on which the light emitting module is provided. Thus, the air flow is unlikely to be generated inside of the concave section and it is possible to prevent the heat from staying inside of the concave section. As a result, it is possible to prevent the heat dissipation from being deteriorated.

A lighting device according to another exemplary embodiment includes the socket described above; and a light emitting module that is provided in the flange section of the socket and has a light emitting element.

In this lighting device, it is possible to improve heat dissipation and resistance with respect to the external force.

Hereinafter, an exemplary embodiment will be described with reference to the drawings. Moreover, the same reference numerals are given to the same configuration elements in each drawing and detailed description will be appropriately omitted.

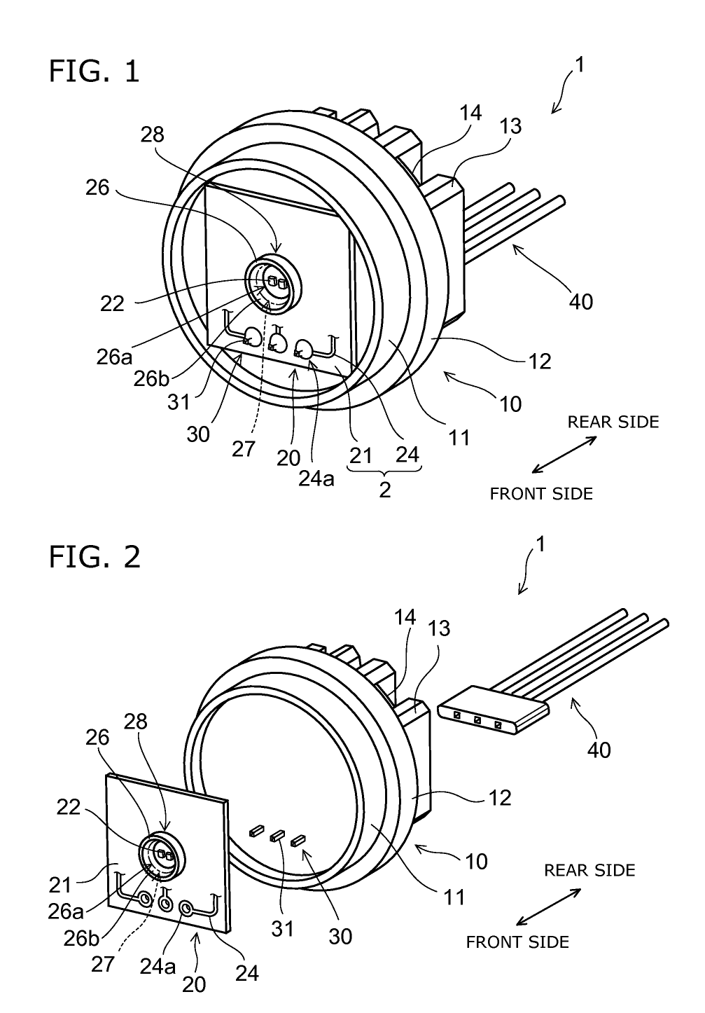

FIG. 1 is a schematic perspective view illustrating a lighting device 1 according to the exemplary embodiment.

FIG. 2 is a schematic exploded view of the lighting device 1.

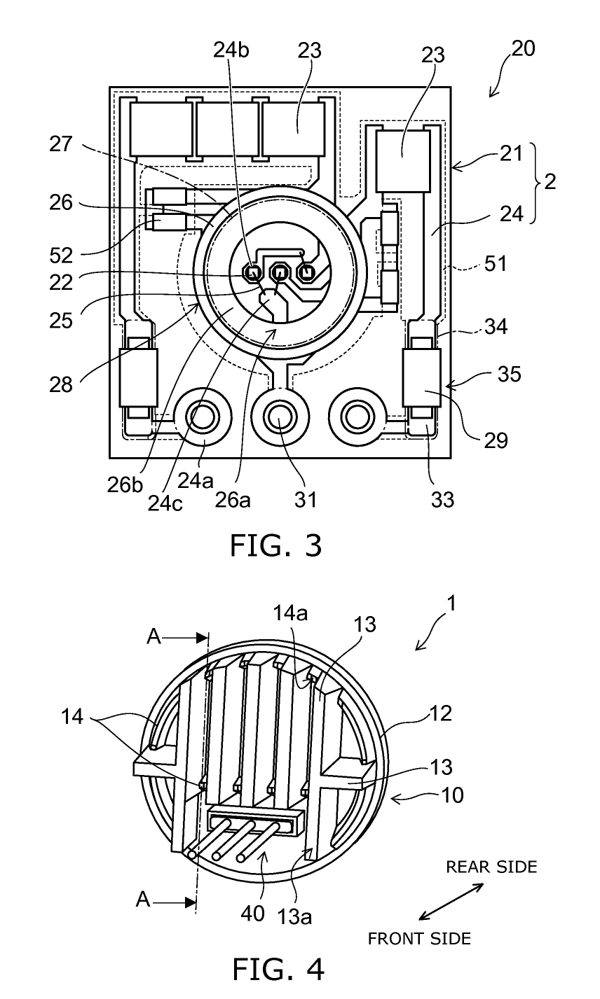

FIG. 3 is a schematic plan view of a light emitting module 20.

As illustrated in FIGS. 1 and 2, the lighting device 1 is provided with a socket 10, a light emitting module 20, a power feeding section 30, and a connector 40.

The socket 10 is provided with a housing section 11, a flange section 12, a fin 13 (corresponding to an example of a first convex section), and a convex section 14 (corresponding to an example of a second convex section).

The housing section 11 has a cylindrical shape and protrudes from one surface of the flange section 12. The light emitting module 20 is provided on the flange section 12 inside of the housing section 11. Furthermore, a power feeding terminal 31 of the power feeding section 30 protrudes on the inside of the housing section 11.

The flange section 12 has a disk shape, the housing section 11 is provided on one surface, and the fin 13 and the convex section 14 are provided on the other surface.

A plurality of fins 13 protrude from the surface of the flange section 12. The plurality of fins 13 have a plate shape and function as heat dissipation fins.

The convex section 14 protrudes from the surface of the flange section 12 and is connected to the fin 13.

Moreover, details regarding the convex section 14 will be described later.

The housing section 11, the flange section 12, the fin 13, and the convex section 14 can be integrally molded or can be connected to each other using adhesive and the like.

However, if the housing section 11, the flange section 12, the fin 13, and the convex section 14 are integrally molded, it is possible to improve heat dissipation, to improve resistance with respect to an external force, to decrease manufacturing costs, and the like.

Furthermore, the socket 10 may be provided with a mounting section (not illustrated) that is used when mounting the lighting device 1 on a lighting apparatus for a vehicle.

As illustrated in FIG. 3, the light emitting module 20 is provided with a light emitting module substrate 2, a light emitting element 22, a control element 23, wiring 25, a surrounding wall member 26, a sealing section 27, a connection section 28, a control element 29, a coating section 51, a metal film 34, and a control element 52.

Furthermore, the light emitting module substrate 2 is provided with a base body 21 and a wiring pattern 24.

The base body 21 is provided on the flange section 12 inside of the housing section 11 of the socket 10.

The base body 21 has a plate shape and the wiring pattern 24 is provided on the surface thereof.

The base body 21 is formed of a ceramic such as aluminum oxide or aluminum nitride.

Furthermore, the base body 21 may be a single-layer or may be a multi-layer.

The wiring pattern 24 is provided on at least one surface of the base body 21.

The wiring pattern 24 can be provided on both surfaces of the base body 21, but in order to reduce the manufacturing costs, it is preferable that the wiring pattern 24 is provided on one surface of the base body 21.

The wiring pattern 24 is provided with an input terminal 24a.

A plurality of input terminals 24a are provided. The input terminal 24a is electrically connected to the power feeding terminal 31 of the power feeding section 30. Thus, the light emitting element 22 is electrically connected to the power feeding section 30 through the wiring pattern 24.

For example, the wiring pattern 24 is formed of a material having silver as a main component. In this case, for example, the wiring pattern 24 is formed of silver or silver alloy. However, a material of the wiring pattern 24 is not limited to the material having silver as a main component and may be a material having copper as a main component.

For example, the wiring pattern 24 can be formed using a screen printing method.

A plurality of light emitting elements 22 are provided on the wiring pattern 24 provided on the surface of the base body 21.

The light emitting element 22 can have electrodes (not illustrated) on a surface (upper surface) opposite to a side on which the wiring pattern 24 is provided. Moreover, the electrodes (not illustrated) may be provided on a surface (lower surface) of a side on which the wiring pattern 24 is provided and the surface (upper surface) opposite to the side on which the wiring pattern 24 is provided, or may be provided only on either side.

The electrodes (not illustrated) provided on the lower surface of the light emitting element 22 are electrically connected to a mounting pad 24b provided in the wiring pattern 24 through a conductive thermosetting material such as silver paste.

The electrodes (not illustrated) provided on the upper surface of the light emitting element 22 are electrically connected to a wiring pad 24c provided in the wiring pattern 24 through the wiring 25.

For example, the light emitting element 22 can be a light emitting diode, an organic light emitting diode, a laser diode, and the like.

The upper surface of the light emitting element 22 that is a light emitting surface faces the front side of the lighting device 1 and mainly emits the light to the front side of the lighting device 1.

The number, a size, arrangement, and the like of the light emitting element 22 are not limited to the example and can be appropriately changed depending on the size, the usage, and the like of the lighting device 1.

The control element 23 is provided on the wiring pattern 24.

The control element 23 controls a current flowing through the light emitting element 22.

Since there is a variation in forward voltage characteristics of the light emitting element 22, if a voltage applied between an anode terminal and a ground terminal is constant, variation occurs in brightness (luminous flux, luminance, light intensity, and illumination) of the light emitting element 22. Thus, a value of the current flowing through the light emitting element 22 is within a predetermined range by the control element 23 such that the brightness of the light emitting element 22 falls within a predetermined range.

For example, the control element 23 can be a resistor. For example, the control element 23 can be a surface mount resistor, a resistor (metal oxide film resistor) having a lead wire, a film-shaped resistor formed using a screen printing method and the like.

Moreover, the control element 23 illustrated in FIG. 3 is the film-shaped resistor.

In this case, the value of the current flowing through the light emitting element 22 can be within a predetermined range by changing a resistance value of the control element 23.

For example, if the plurality of control element 23 are the film-shaped resistor, a removal section (not illustrated) is formed for the plurality of control element 23 by removing a part thereof. Then, a resistance value is changed for the plurality of control element 23 by a size and the like of the removal section. In this case, if a part of the control element 23 is removed, the resistance value is increased. For example, removal of a part of the control element 23 can be performed by irradiating the control element 23 with laser light.

The number, the size, the arrangement, and the like of the control element 23 are not limited to the exemplary embodiment and can be appropriately changed depending on the number or specification and the like of the light emitting element 22.

The wiring 25 electrically connects the electrodes (not illustrated) provided on the upper surface of the light emitting element 22 and the wiring pad 24c provided in the wiring pattern 24.

For example, the wiring 25 can be a wire having gold as a main component. However, a material of the wiring 25 is not limited to the material having gold as the main component, for example, and may be a material having copper as a main component, or a material having aluminum as a main component.

For example, the wiring 25 electrically connects the electrodes (not illustrated) provided on the upper surface of the light emitting element 22 and the wiring pad 24c provided in the wiring pattern 24 by ultrasonic welding or heat welding. For example, the wiring 25 can electrically connect the electrodes (not illustrated) provided on the upper surface of the light emitting element 22 and the wiring pad 24c provided in the wiring pattern 24 using a wire bonding method.

The surrounding wall member 26 is provided on the base body 21 so as to surround the plurality of light emitting elements 22. For example, the surrounding wall member 26 has a circular shape and is provided such that the plurality of light emitting elements 22 are disposed at a center portion 26a.

For example, the surrounding wall member 26 can be formed of resin such as polybutylene terephthalate (PBT) or polycarbonate (PC), or ceramics, and the like.

Furthermore, if the material of the surrounding wall member 26 is resin, it is possible to improve a reflectance of the light emitted from the light emitting element 22 by mixing particles of titanium oxide and the like.

Moreover, it is not limited to the particles of titanium oxide and particles formed of a material having a high reflectance of the light emitted from the light emitting element 22 may be mixed.

Furthermore, for example, the surrounding wall member 26 can be formed of white resin.

A side wall surface 26b on the side of the center portion 26a of the surrounding wall member 26 is an inclined surface. Some of the light emitted from the light emitting element 22 is reflected on the side wall surface 26b of the surrounding wall member 26 and is emitted to the front side of the lighting device 1.

Furthermore, the light that is a part of the light emitted from the light emitting element 22 to the front side of the lighting device 1 and is totally reflected on the upper surface (an interface between the sealing section 27 and the outside air) of the sealing section 27 is reflected on the side wall surface 26b on the side of the center portion 26a of the surrounding wall member 26 and is re-emitted to the front side of the lighting device 1.

That is, the surrounding wall member 26 can also have a reflector function.

Moreover, a shape of the surrounding wall member 26 is not limited to the exemplary embodiment and can be appropriately changed.

The sealing section 27 is provided in the center portion 26a of the surrounding wall member 26. The sealing section 27 is provided to cover the inside of the surrounding wall member 26. That is, the sealing section 27 is provided inside of the surrounding wall member 26 and covers the light emitting element 22 and the wiring 25.

The sealing section 27 is formed of a light-transmitting material. For example, the sealing section 27 can be formed of silicone resin and the like.

For example, the sealing section 27 can be formed by filling resin at the center portion 26a of the surrounding wall member 26. For example, the filling of resin can be performed using a liquid dispensing device such as dispenser.

If resin is filled at the center portion 26a of the surrounding wall member 26, it is possible to prevent mechanical contact from outside with respect to the light emitting element 22, the wiring pattern 24 disposed at the center portion 26a of the surrounding wall member 26, and the wiring 25. Furthermore, it is possible to prevent attachment of moisture or gas, and the like to the light emitting element 22, the wiring pattern 24 disposed at the center portion 26a of the surrounding wall member 26, and the wiring 25. Thus, it is possible to improve reliability of the lighting device 1.

Furthermore, the sealing section 27 can include a phosphor. For example, the phosphor can be a YAG-based phosphor (yttrium-aluminum-garnet-based phosphor).

For example, if the light emitting element 22 is a blue light emitting diode and the phosphor is the YAG-based phosphor, the YAG-based phosphor is excited by the blue light emitted from the light emitting element 22 and yellow fluorescence is emitted from the YAG-based phosphor. Then, white light is emitted from the lighting device 1 by mixing blue light and yellow light. Moreover, kinds of phosphor or kinds of the light emitting element 22 are not limited to the exemplary embodiment and can be appropriately changed to obtain a desired light emitting color depending on the usage of the lighting device 1.

The connection section 28 connects the surrounding wall member 26 and the base body 21.

The connection section 28 has a film shape and is provided between the surrounding wall member 26 and the base body 21.

For example, the connection section 28 can be formed by curing silicone-based adhesive or epoxy-based adhesive.

The control element 29 is provided on the wiring pattern 24 through a soldering section 33. That is, the control element 29 is soldered on the wiring pattern 24.

The control element 29 is provided such that a reverse voltage is not applied to the light emitting element 22 and pulse noise is not applied to the light emitting element 22 from a reverse direction.

For example, the control element 29 can be a diode. For example, the control element 29 can be surface-mounted diode, or a diode having a lead wire, and the like.

The control element 29 illustrated in FIG. 3 is the surface-mounted diode.

The control element 52 is provided on the wiring pattern 24.

The control element 52 is provided to detect disconnection of the light emitting diode or to prevent erroneous lighting and the like. The control element 52 is a pull-down resistor.

The control element 52 can be a film-shaped resistor that is formed using the screen printing method and the like.

For example, the control element 52 can be the film-shaped resistor that is formed using ruthenium oxide.

The coating section 51 is provided to cover a part of the wiring pattern 24, the control element 23 that is the film-shaped resistor, and the control element 52 that is the film-shaped resistor.

Moreover, the coating section 51 is not provided in a region in which the control element 29 and the light emitting element 22 are provided, a region to which the wiring 25 is connected, and a region to which the power feeding terminal 31 is connected.

For example, the coating section 51 does not cover a region 35 in which the control element 29 is soldered.

The coating section 51 is provided such that moisture, gas, and the like are prevented from coming into contact with the wiring pattern 24, the control element 23, and the control element 52, and electrical insulation is ensured. The coating section 51 can include a glass material.

As described above, for example, the wiring pattern 24 is formed of the material having silver as the main component. Thus, migration may be generated by energizing under high-humidity conditions.

For example, a short circuit may occur between the soldering sections 33 facing each other.

Thus, in order to suppress the migration and to improve solder wettability, the metal film 34 covering the wiring pattern 24 is provided.

Furthermore, for example, in a case where the wiring pattern 24 is formed of the material having copper as the main component, if the wiring pattern 24 is used under high-temperature conditions or under an atmosphere in which a sulfur component is large, oxidation or reaction of sulfur is fast, and solder wettability may be lowered. Thus, the metal film 34 covering the wiring pattern 24 is provided.

The metal film 34 is provided in the soldered region 35 and covers the wiring pattern 24. For example, the metal film 34 can be a laminated film at least having a film formed of nickel and a film formed of gold. For example, the metal film 34 can be a laminated film in which a film formed of nickel and a film formed of gold are laminated in this order, and a laminated film in which a film formed of nickel, a film formed of palladium, and a film formed of gold are laminated in this order, and the like.

For example, the metal film 34 is formed in the soldered region 35 using an electroless plating method.

The power feeding section 30 is provided with the plurality of power feeding terminals 31.

The plurality of power feeding terminals 31 extend inside of the housing section 11 and the flange section 12. One end portion of the plurality of power feeding terminals 31 protrudes from the surface of the flange section 12 and is electrically connected to the input terminal 24a of the wiring pattern 24. The other end portion of the plurality of power feeding terminals 31 is exposed from a side of the socket 10 opposite to the side in which the base body 21 is provided.

Moreover, the number, arrangement, the shape, and the like of the power feeding terminal 31 are not limited to the exemplary embodiment and can be appropriately changed.

Furthermore, the power feeding section 30 can include a substrate (not illustrated), or circuit components such as a capacitor, and a resistor. Moreover, for example, the substrate (not illustrated) or the circuit components can be provided inside of the housing section 11 or inside of the flange section 12, and the like.

The connector 40 is fitted to the end portion of the plurality of power feeding terminals 31 exposed from the socket 10.

The connector 40 is electrically connected to a power supply (not illustrated) and the like.

Thus, the power supply (not illustrated) and the like, and the light emitting element 22 are electrically connected to each other by fitting the connector 40 to the end portion of the power feeding terminal 31.

For example, the connector 40 can be connected to an element on the side of the socket 10 using adhesive and the like.

Next, the convex section 14 is further illustrated.

As described above, the socket 10 has a function for housing the light emitting module 20, the power feeding section 30, and the like, and a function for releasing the heat generated by the light emitting module 20 or the power feeding section 30 to the outside of the lighting device 1.

Thus, the socket 10 is formed of a material having a high thermal conductivity considering release of the heat to the outside.

As the material having the high thermal conductivity, there is metal such as aluminum and if the socket 10 is formed of the metal, a weight is increased or manufacturing costs are increased.

Furthermore, if the socket 10 is formed of a general resin material, it is possible to reduce the weight, but heat dissipation is deteriorated.

Thus, the material of the socket 10 is a so-called heat-conductive resin.

For example, the heat-conductive resin can be a resin having the high thermal conductivity by containing filler formed of carbon and the like.

In this case, a portion such as the fin 13 in which the heat is discharged to the outside is formed of the thermally conductive resin and the other portions can be formed of the resin and the like.

Furthermore, if the thermally conductive resin has a conductivity, in order to ensure electrical insulation between the power feeding terminal 31 and elements formed of the heat-conductive resin, a periphery of the power feeding terminal 31 is covered by an insulation section that is formed of an insulation material and an element formed of the heat-conductive resin can be provided at the periphery of the insulation section.

Here, if a content amount of the filler is increased, it is possible to increase the thermal conductivity. However, if the content amount of the filler is increased, brittleness is increased and resistance (mechanical strength) with respect to the external force is decreased.

The fin 13 has a plate shape such that air easily flows between the fins 13.

Thus, if the fin 13 and the flange section 12 are integrally molded, a thickness of the fin 13 is necessary to be thin to some extent to suppress shrinkage (recessed and deformation) during molding. Thus, if the fin 13 is molded using the heat-conductive resin, the resistance of the fin 13 with respect to the external force is lowered and cracking and the like easily occur in a connection portion (a base of the fin 13) between the fin 13 and the flange section 12, and the like.

Thus, in the exemplary embodiment, the convex section 14 that connects the fin 13 and the flange section 12 is provided.

FIG. 4 is a schematic perspective view illustrating the convex section 14.

Moreover, FIG. 4 is a view of the lighting device 1 viewed from a rear side (side opposite to the side in which the light emitting module 20 is provided).

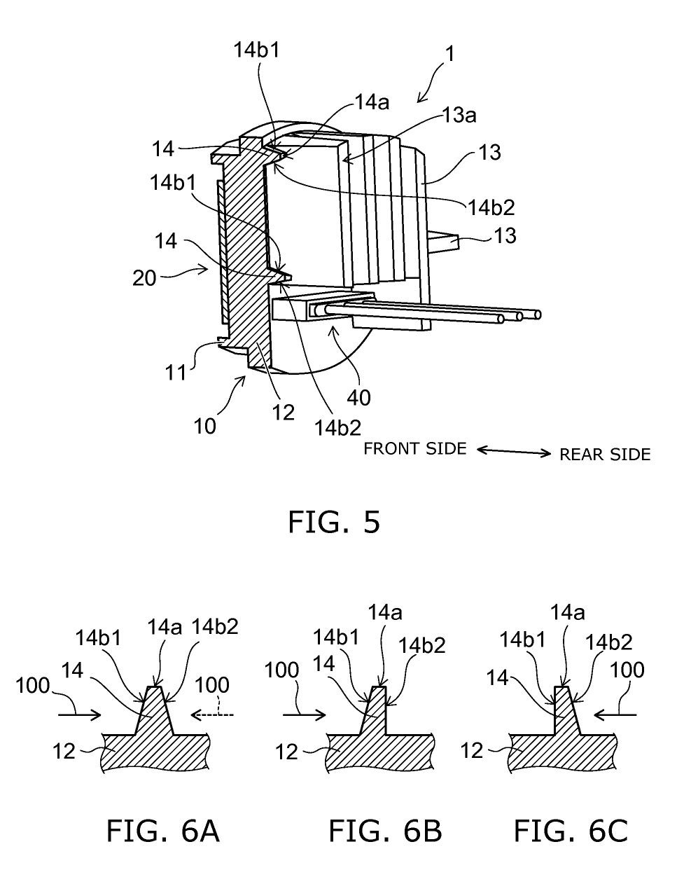

FIG. 5 is a cross-sectional view that is taken along line A-A in FIG. 4.

FIGS. 6A to 6C are schematic cross-sectional views illustrating a cross section shape of the convex section 14.

As illustrated in FIGS. 4 and 5, the convex section 14 protrudes from the surface of the flange section 12.

Furthermore, the convex section 14 is connected to the fin 13.

In this case, the convex section 14 can be provided between one fin 13 and the other fin 13 adjacent to the one fin 13.

Then, the convex section 14 can be connected to at least one of the one fin 13 and the other fin 13.

That is, the base side of the fin 13 is connected to the convex section 14.

Thus, it is possible to improve the resistance of the fin 13 with respect to the external force.

In this case, it is possible to intersect a direction in which the fin 13 extends and a direction in which the convex section 14 extends. Thus, it is possible to improve the resistance of the fin 13 with respect to the external force.

Furthermore, the convex section 14 is connected to the flange section 12 in which the light emitting module 20 that is a heat source is provided.

Thus, the convex section 14 also functions as a heat dissipation fin.

If the convex section 14 is provided, it is possible to improve the heat dissipation.

Here, flow of air is formed in the vicinity of the fin 13 by natural convection. Thus, if the flow of air is obstructed by the convex section 14, there is a concern that the improvement of the heat dissipation is not achieved.

In this case, if the convex section 14 is provided between the fin 13 and the other fin 13, the flow of air is obstructed easily between the fins 13.

Thus, a position of a top surface 14a of the convex section 14 is further on the flange section 12 side with respect to a position of a top surface 13a of the fin 13. That is, a height of the convex section 14 is lower than a height of the fin 13.

Thus, even if the convex section 14 is provided, it is possible to prevent the flow of air from being obstructed in the vicinity of the fin 13.

As a result, it is possible to improve the heat dissipation.

Furthermore, as illustrated in FIG. 5, the convex section 14 has a first surface 14b1 intersecting the fin 13 and a second surface 14b2 facing the first surface 14b1.

At least one of the first surface 14b1 and the second surface 14b2 is inclined such that a distance between the first surface 14b1 and the second surface 14b2 is gradually shortened toward the top surface 14a of the convex section 14.

That is, at least one of the first surface 14b1 and the second surface 14b2 is an inclined surface.

In this case, as illustrated in FIG. 6A, both the first surface 14b1 and the second surface 14b2 can be inclined surfaces.

If both the first surface 14b1 and the second surface 14b2 are the inclined surfaces, inclining directions thereof are opposite to each other.

Furthermore, as illustrated in FIGS. 6B and 6C, the first surface 14b1 or the second surface 14b2 can be the inclined surface.

Furthermore, if a plurality of convex sections 14 are provided, the first surface 14b1 of each of the plurality of convex sections 14 can be inclined in the same direction. The second surface 14b2 of each of the plurality of convex sections 14 can be inclined in the same direction.

If the inclined surface is provided, it is possible to prevent occurrence of turbulence in the flow of air.

Thus, since the flow of air can be smooth, it is possible to improve the heat dissipation.

In this case, as illustrated in FIGS. 6B and 6C, a surface of an upstream side in an airflow direction 100 can be the inclined surface.

Moreover, the airflow direction 100 is affected by a mounting shape of the lighting device 1 or environment in which the lighting device 1 is mounted, and the like.

Thus, as illustrated in FIG. 6A, if two surfaces (the first surface 14b1 and the second surface 14b2) facing each other are inclined surfaces and the inclination directions are opposite to each other, it is possible to correspond a case where the airflow direction 100 is not known in advance or the airflow direction 100 is changed.

Next, a lighting device 101 according to another exemplary embodiment will be described.

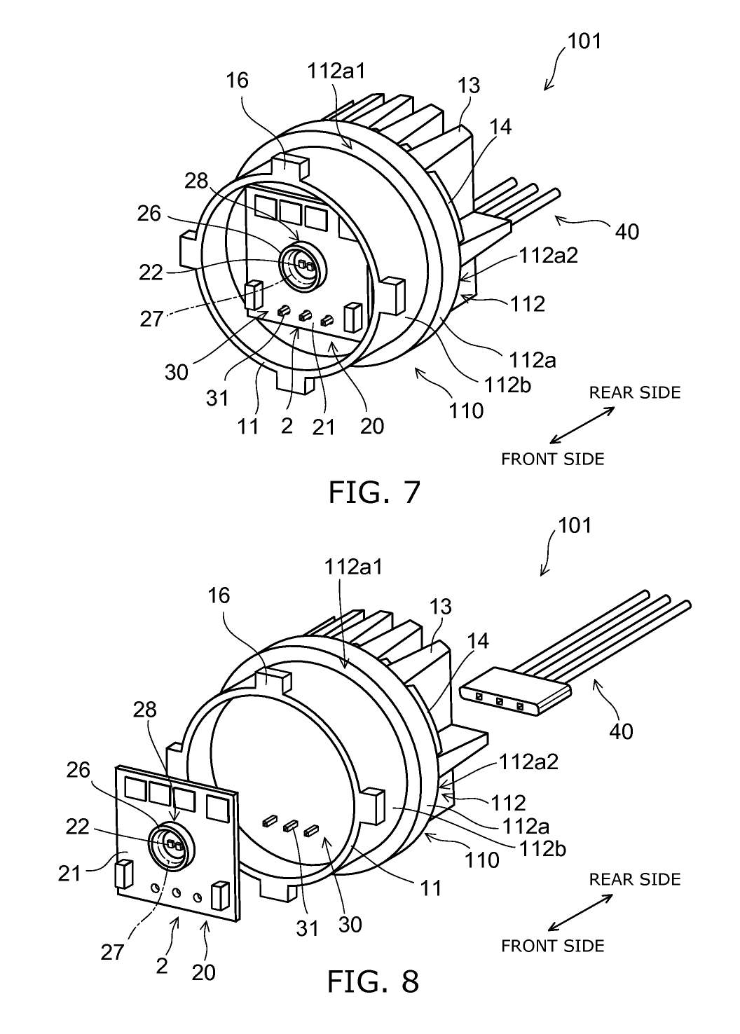

FIG. 7 is a schematic perspective view illustrating the lighting device 101 according to another exemplary embodiment.

FIG. 8 is a schematically exploded perspective view of the lighting device 101.

As illustrated in FIGS. 7 and 8, the lighting device 101 is provided with a socket 110, a light emitting module 20, a power feeding section 30, and a connector 40.

The socket 110 is provided with a housing section 11, a flange section 112, a fin 13, a convex section 14, a convex section 15 (corresponding to an example of third convex section), and a mounting section 16.

The housing section 11 has a cylindrical shape and protrudes from a convex section 112b of the flange section 112. A light emitting module 20 is provided on the convex section 112b of the flange section 112 inside of the housing section 11. Furthermore, the power feeding terminal 31 of the power feeding section 30 protrudes on the inside of the housing section 11.

The flange section 112 has a base section 112a, a convex section 112b, and a concave section 112c.

The base section 112a has a disk shape.

The convex section 112b is provided in a surface 112a1 of the base section 112a that is a front side of the lighting device 101.

That is, the convex section 112b protrudes from one surface of the base section 112a. The light emitting module 20 having the light emitting element 22 is provided on the convex section 112b.

The concave section 112c is provided in a surface 112a2 of the base section 112a that is in a rear side of the lighting device 101 (see FIG. 10).

That is, the concave section 112c is provided in the surface 112a2 of the base section 112a opposite to a side in which the light emitting module 20 is provided.

Furthermore, the fin 13 and the convex section 14 are provided in the surface 112a2 of the base section 112a that is in the rear side of the lighting device 101.

The fin 13 protrudes from the surface 112a2 of the base section 112a that is in the rear side of the lighting device 101. A plurality of fins 13 are provided. The plurality of fins 13 have a plate shape and function as a heat dissipation fin.

The convex section 14 protrudes from the surface 112a2 of the base section 112a that is in the rear side of the lighting device 101 and is connected to the fin 13.

The convex section 15 is provided inside of the concave section 112c and a leading end thereof protrudes from the surface 112a2 of the base section 112a that is in the rear side of the lighting device 101.

That is, the convex section 15 is provided inside of the concave section 112c and protrudes from a surface of the base section 112a opposite to the side in which the light emitting module 20 is provided.

The convex section 15 is connected to the fin 13.

The housing section 11, the flange section 112, the fin 13, the convex section 14, and the convex section 15 can be integrally formed or can be connected to each other using adhesive and the like.

However, if the housing section 11, the flange section 112, the fin 13, the convex section 14, and the convex section 15 are integrally formed, it is possible to improve heat dissipation, to improve resistance with respect to an external force, to decrease manufacturing costs, and the like.

The mounting section 16 is provided on a side wall of the housing section 11 and protrudes toward the outside of the lighting device 101.

A plurality of mounting sections 16 are provided.

The mounting section 16 is inserted into a groove section that is provided in the lighting apparatus for the vehicle when mounting the lighting device 101 on the lighting apparatus for the vehicle. Then, the lighting device 101 is held in the lighting apparatus for the vehicle by rotating the lighting device 101.

That is, the mounting section 16 is used for twist-lock.

Next, the convex section 112b, the concave section 112c of the flange section 112, the convex section 14, and the convex section 15 are further described.

The socket 110 has a function for housing the light emitting module 20, the power feeding section 30, and the like, and a function for releasing the heat generated by the light emitting module 20 or the power feeding section 30 to the outside of the lighting device 101.

Thus, the socket 110 is formed of a material having a high thermal conductivity considering release of the heat to the outside.

The socket 110 can be formed of heat-conductive resin similar to the socket 10 described above.

In this case, similar to the socket 10 described above, if a content amount of the filler is increased, it is possible to increase the thermal conductivity. However, if the content amount of the filler is increased, brittleness is increased and resistance (mechanical strength) with respect to the external force is decreased.

Thus, if the fin 13 is molded using the heat-conductive resin, the resistance of the fin 13 with respect to the external force is lowered and cracking and the like easily occur in a connection portion (a base of the fin 13) between the fin 13 and the flange section 112, and the like.

Thus, also in the socket 110, the convex section 14 connecting between the fin 13 and the flange section 112 is provided.

Furthermore, as described above, the light emitting module 20 is provided inside of the housing section 11.

Thus, light emitted from the light emitting element 22 is easily blocked by the mounting section 16 provided on the housing section 11 or a side wall of the housing section 11.

In this case, if a mounting position of the light emitting module 20 is near the front side of the lighting device 101, it is possible to prevent light emitted from the light emitting element 22 from being blocked by the housing section 11 or the mounting section 16.

Thus, the convex section 112b protruding from the base section 112a to the front side of the lighting device 101 is provided and the light emitting module 20 is provided in the convex section 112b. That is, the convex section 112b is provided and a mounting position of the light emitting module 20 is near the front side of the lighting device 101.

However, if the convex section 112b is provided, a thickness of the flange section 112 is thick by the convex section 112b and a weight is increased or material costs are increased.

Thus, the weight or the material costs are suppressed by providing the concave section 112c in the surface 112a2 of the base section 112a that is in the rear side of the lighting device 101.

However, since the flow of air is unlikely to occur inside the concave section 112c, there is a concern that the heat is accumulated and the heat dissipation is deteriorated inside the concave section 112c.

Thus, in the socket 110, the convex section 15 that is connected to the fin 13 is provided inside of the concave section 112c.

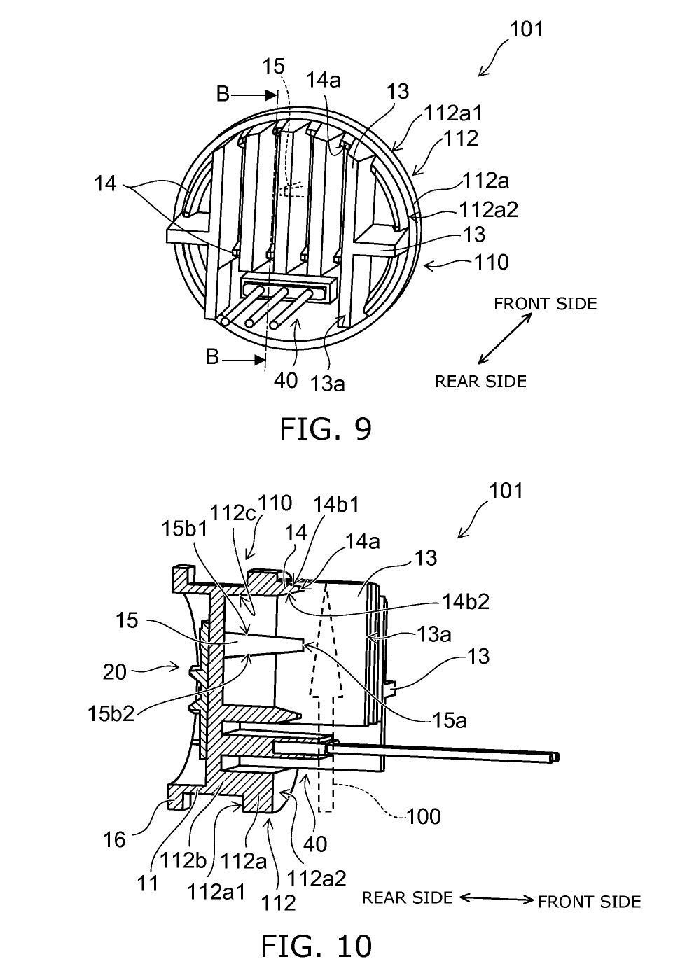

FIG. 9 is a schematic perspective view illustrating the convex section 14 and the convex section 15.

Moreover, FIG. 9 is a view of the lighting device 101 viewed from the rear side (side opposite to the side in which the light emitting module 20 is provided).

FIG. 10 is a cross-sectional view that is taken along line B-B in FIG. 9.

As illustrated in FIGS. 9 and 10, the convex section 14 protrudes from the surface 112a2 of the base section 112a that is in the rear side of the lighting device 101 and is connected to the fin 13.

In this case, the convex section 14 can be provided between one fin 13 and the other fin 13 adjacent to the one fin 13.

Then, the convex section 14 can be connected to at least one of the one fin 13 and the other fin 13.

That is, the base side of the fin 13 is connected to the convex section 14.

Thus, it is possible to improve the resistance of the fin 13 with respect to the external force.

In this case, it is possible to intersect a direction in which the fin 13 extends and a direction in which the convex section 14 extends. Thus, it is possible to improve the resistance of the fin 13 with respect to the external force.

Furthermore, the convex section 14 is connected to the flange section 112 in which the light emitting module 20 that is a heat source is provided.

Thus, the convex section 14 also functions as a heat dissipation fin.

If the convex section 14 is provided, it is possible to improve the heat dissipation.

Here, the flow of air is formed in the vicinity of the fin 13 by a natural convection. Thus, if the flow of air is obstructed by the convex section 14, there is a concern that the improvement of the heat dissipation is not achieved.

In this case, if the convex section 14 is provided between the fin 13 and the other fin 13, the flow of air is obstructed easily between the fins 13.

Thus, a position of a top surface 14a of the convex section 14 is further on the flange section 12 side with respect to a position of a top surface 13a of the fin 13. That is, a height of the convex section 14 is lower than a height of the fin 13.

Thus, even if the convex section 14 is provided, it is possible to prevent the flow of air from being obstructed in the vicinity of the fin 13.

As a result, it is possible to improve the heat dissipation.

Furthermore, as illustrated in FIGS. 9 and 10, the convex section 15 is provided inside of the concave section 112c.

Furthermore, a leading end of the convex section 15 protrudes from the surface 112a2 of the base section 112a that is in the rear side of the lighting device 101. The convex section 15 is connected to the fin 13.

In this case, the convex section 15 can be provided between one fin 13 and the other fin 13 adjacent to the one fin 13.

Then, the convex section 15 can be connected to at least one of the one fin 13 and the other fin 13.

That is, the base side of the fin 13 is connected to the convex section 15.

Thus, it is possible to improve the resistance of the fin 13 with respect to the external force.

In this case, it is possible to intersect a direction in which the fin 13 extends and a direction in which the convex section 15 extends. Thus, it is possible to improve the resistance of the fin 13 with respect to the external force.

As described above, since the flow of air is unlikely to occur inside the concave section 112c, the heat is easily accumulated inside the concave section 112c.

In this case, if the convex section 15 is provided inside of the concave section 112c and the convex section 15 is connected to the fin 13, the heat inside the concave section 112c can escape to the fin 13.

As described above, the convex section 15 also functions as the heat transmitting section and the heat dissipation fin.

Thus, if the convex section 15 is provided, since the heat inside the concave section 112c can be escaped, it is possible to improve the heat dissipation.

Furthermore, similar to the convex section 14 described above, a position of a top surface 15a of the convex section 15 is closer on the flange section 112 side than the position of the top surface 13a of the fin 13.

Thus, even if the convex section 15 is provided, it is possible to prevent the flow of air from being obstructed in the vicinity of the fin 13.

In this case, the position of the top surface 15a of the convex section 15 in a protruding direction (height direction) of the convex section 15 can be the same as the position of the top surface 14a of the convex section 14.

Thus, it is possible to prevent occurrence of turbulence in the flow of air.

Thus, since the flow of air can be smooth, it is possible to improve the heat dissipation.

Furthermore, as illustrated in FIG. 10, the convex section 15 has a surface 15b1 (corresponding to an example of a third surface) intersecting the fin 13 and a surface 15b2 (corresponding to an example of a fourth surface) facing the surface 15b1.

At least one of the surface 15b1 and the surface 15b2 is inclined such that a distance between the surface 15b1 and the surface 15b2 is gradually shortened toward the top surface 15a of the convex section 15.

That is, at least one of the surface 15b1 and the surface 15b2 is an inclined surface.

Furthermore, similar to the convex section 14 illustrated in FIG. 6A, both the surface 15b1 and the surface 15b2 can be the inclined surface.

If both the surface 15b1 and the surface 15b2 are the inclined surface, the inclination directions are opposite to each other.

Furthermore, similar to the convex section 14 illustrated in FIGS. 6B and 6C, the surface 15b1 or the surface 15b2 can be the inclined surface.

Furthermore, if a plurality of convex sections 15 are provided, the surface 15b1 of each of the plurality of convex sections 15 can be inclined in the same direction. The surface 15b2 of each of the plurality of convex sections 15 can be inclined in the same direction.

If the inclined surface is provided, it is possible to prevent occurrence of turbulence in the flow of air.

Thus, since the flow of air can be smooth, it is possible to improve the heat dissipation.

In this case, similar to the convex section 14 illustrated in FIGS. 6B and 6C, a surface of an upstream side in an airflow direction 100 can be the inclined surface.

Moreover, the airflow direction 100 is affected by a mounting shape of the lighting device 101 or environmental in which the lighting device 101 is mounted, and the like.

Thus, similar to the convex section 14 illustrated in FIG. 6A, if two surfaces (the surface 15b1 and the surface 15b2) facing each other are inclined surfaces and the inclination directions are opposite to each other, it is possible to correspond a case where the airflow direction 100 is not known in advance or the airflow direction 100 is changed.

While certain exemplary embodiments have been described, these exemplary embodiments have been presented by way of example only, and are not intended to limit the scope of the inventions. Indeed, the novel exemplary embodiments described herein may be embodied in a variety of other forms; furthermore, various omissions, substitutions and changes in the form of the exemplary embodiments described herein may be made without departing from the spirit of the inventions. The accompanying claims and their equivalents are intended to cover such forms or modifications as would fall within the scope and spirit of the inventions. Moreover, above-mentioned exemplary embodiments can be combined mutually and can be carried out.

What is claimed is:

1. A socket comprising:
a flange section in which a light emitting module having a light emitting element is provided;
a first convex section that protrudes from a surface of the flange section opposite to a side on which the light emitting module is provided and has a plate shape; and
a second convex section that protrudes from the surface of the flange section opposite to the side on which the light emitting module is provided and is connected to the first convex section,
wherein a top surface of the second convex section is positioned further on the flange section side with respect to a top surface of the first convex section.

2. The socket according to claim 1,
wherein a plurality of first convex sections are provided,
wherein the second convex section is provided between one first convex section and another first convex section, and
wherein the second convex section is connected to at least one of the one first convex section and the other first convex section.

3. The socket according to claim 1,
wherein the second convex section has a first surface intersecting the first convex section and a second surface facing the first surface, and
wherein at least one of the first surface and the second surface is inclined such that a distance between the first surface and the second surface is gradually shortened toward the top surface of the second convex section.

4. The socket according to claim 3,
wherein a plurality of the second convex sections are provided, and
wherein the first surface of each of the plurality of second convex sections is inclined in the same direction.

5. The socket according to claim 3,
wherein a plurality of the second convex sections are provided, and
wherein the second surface of each of the plurality of second convex sections is inclined in the same direction.

6. The socket according to claim 1, further comprising:
a third convex section that is connected to the first convex section,
wherein the flange section has a base section, a convex section which protrudes from one surface of the base section and in which the light emitting module is provided, and a concave section that is provided on a surface of the base section opposite to a side on which the light emitting module is provided,
wherein the first convex section protrudes from the surface of the base section opposite to the side on which the light emitting module is provided,
wherein the third convex section is provided inside of the concave section and protrudes from the surface of the base section opposite to the side on which the light emitting module is provided, and
wherein a top surface of the third convex section is positioned further on the base section side with respect to the top surface of the first convex section.

7. The socket according to claim 6,
wherein the third convex section has a third surface intersecting the first convex section and a fourth surface facing the third surface, and
wherein at least one of the third surface and the fourth surface is inclined such that a distance between the third surface and the fourth surface is gradually shortened toward the top surface of the third convex section.

8. The socket according to claim 6,
wherein the second convex section protrudes from the surface of the base section opposite to the side on which the light emitting module is provided, and
wherein the top surface of the second convex section is positioned further on the base section side with respect to the top surface of the first convex section.

9. The socket according to claim 1,
wherein the first convex section includes a thermally conductive resin.

10. The socket according to claim 9,
wherein the thermally conductive resin has filler including carbon.

11. The socket according to claim 1,
wherein the second convex section includes a thermally conductive resin.

12. The socket according to claim 11,
wherein the thermally conductive resin has filler including carbon.

13. The socket according to claim 6,
wherein the third convex section includes a thermally conductive resin.

14. The socket according to claim 13,
wherein the thermally conductive resin has filler including carbon.

15. The socket according to claim 1,
wherein the flange section includes a thermally conductive resin.

16. The socket according to claim 15,
wherein the thermally conductive resin has filler including carbon.

17. The socket according to claim 1,
wherein the flange section, the first convex section, the second convex section, and the third convex section are integrally formed.

18. A lighting device comprising:
a socket; and
a light emitting module that is provided in the socket and has a light emitting element,
wherein the socket includes
a flange section in which a light emitting module having a light emitting element is provided;
a first convex section that protrudes from a surface of the flange section opposite to a side on which the light emitting module is provided and has a plate shape; and
a second convex section that protrudes from the surface of the flange section opposite to the side on which the light emitting module is provided and is connected to the first convex section,
wherein a top surface of the second convex section is positioned further on the flange section side with respect to a top surface of the first convex section.

19. The lighting device according to claim 18, further comprising:
a third convex section connected to the first convex section,
wherein the flange section has a base section, a convex section which protrudes from one surface of the base section and in which the light emitting module is provided, and a concave section that is provided on a surface of the base section opposite to a side on which the light emitting module is provided,
wherein the first convex section protrudes from the surface of the base section opposite to the side on which the light emitting module is provided,
wherein the third convex section is provided inside of the concave section and protrudes from the surface of the base section opposite to the side on which the light emitting module is provided, and
a top surface of the third convex section is positioned further on the base section side with respect to the top surface of the first convex section.

20. The lighting device according to claim 18,
wherein the flange section, the first convex section, and the second convex section include a thermally conductive resin.
